(19) United States
(12) Patent Application Publication
(10) Pub. No.: US 2017/0150579 A1
(43) Pub. Date: May 25, 2017

(54) SYSTEM AND METHOD FOR RESPONSIVE LIGHTING

(71) Applicant: INTELIRAM TECHNOLOGIES LTD, Petach-Tikva (IL)

(72) Inventors: Yuvalal Liron, Tel-Aviv (IL); Dov Bruker, Hod Hasharon (IL)

(21) Appl. No.: 15/359,718

(22) Filed: Nov. 23, 2016

Related U.S. Application Data
(60) Provisional application No. 62/259,098, filed on Nov. 24, 2015.

(51) Int. Cl. H05B 37/02; G01J 1/42; H05B 33/08

(52) U.S. Cl. CPC H05B 37/0227; H05B 33/0848; G01J 1/4204

(57) ABSTRACT

A method and a system for controlling an illumination level of a location is disclosed. The system includes: a light source, a light sensor, a processor and a memory. The method includes: calculating a light absorbance factor for the location, the light absorbance factor being a function of at least a distance of the location from the light sensor and an amount of light collected by the sensor in an area of the location upon an activation of the light source and calculating an illumination level based on the calculated light absorbance factor. The method further includes iteratively altering an illumination intensity of the light source until the calculated illumination level of the location is achieved.

### CROSS REFERENCE TO RELATED APPLICATIONS

This application claims the benefit of U.S. Provisional Application Ser. No. 62/259,098, filed on Nov. 24, 2015 (and entitled SYSTEM AND METHOD FOR RESPONSIVE LIGHTING), which is incorporated in its entirety herein by reference.

### BACKGROUND

Indoor spaces with dedicated uses may require lighting that matches such uses. Schools, restaurants and offices may require that illumination levels be maintained at the desks, tables and work spaces that populate such spaces. For factories, museums and walkways, lighting requirements may seek to illuminate floors, wall installations or other particular areas or surfaces. Light that is directed or focused other than at the desired areas may be wasted. Such wasted light is costly and inefficient.

### SUMMARY

Some embodiments of the invention may be related to a system for controlling an illumination level of a location. The system may include: a light source to produce an illumination, a light sensor to measure an illumination level and a memory to store a measure of distance between the light sensor and the location and to store an illumination level produced by the light source at a pre-defined distance. The system may further include a processor to: calculate a light absorbance factor for the location, the light absorbance factor being a function of at least the distance of the location from the light sensor and an amount of light collected by the light sensor in an area of the location upon an activation of the light source and calculate an illumination level based on the calculated light absorbance factor. The may further iteratively alter an illumination intensity of the light source until the calculated illumination level of the location is achieved.

Some embodiments of the invention may be related to a method of controlling an illumination level of a location. The method may include calculating a light absorbance factor for the location, the light absorbance factor being a function of at least a distance of the location from the light sensor and an amount of light collected by the light sensor in an area of the location upon an activation of the light source and calculating an illumination level based on the calculated light absorbance factor. The method may further include iteratively altering an illumination intensity of the light source until the calculated illumination level of the location is achieved.

### BRIEF DESCRIPTION OF THE DRAWINGS

The subject matter regarded as the invention is particularly pointed out and distinctly claimed in the specification. Embodiments of the invention, however, both as to organization and method of operation, together with objects, features, and advantages thereof, may best be understood by reference to the following detailed description when read with the accompanying drawings in which:

FIG. 1 is a diagrammatic representation of a system for controlling illumination level of a location according to some embodiments of the invention;

FIG. 2 is a schematic diagram of a light source installation in accordance with an embodiment of the invention;

FIGS. 3A, 3B and 3C are schematic diagrams of light sources, light sensors and surfaces in accordance with an embodiment of the invention; and

FIG. 4 is a flow diagram of a method of controlling an illumination level location according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, discussions utilizing terms such as, for example, “processing,”“computing,”“calculating,”“determining,”“establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

The processes and functions presented herein are not inherently related to any particular computer, network or other apparatus. Embodiments of the invention described herein are not described with reference to any particular programming language, machine code, etc. It will be appreciated that a variety of programming languages, network systems, protocols or hardware configurations may be used to implement the teachings of the embodiments of the invention as described herein. In some embodiments, one or more methods of embodiments of the invention may be stored on an article such as a memory device, where such instructions upon execution by for example one or more processors results in a method of an embodiment of the invention. In some embodiments, one or more components of a system may be associated with other components by way of a wired or wireless network. For example one or more memory units and one or more processors may be in separate locations and connected by wired or wireless communications to execute such instructions.

As used in this application, the term ‘light source’ may in addition to its regular meaning, include one or more incandescent, fluorescent, halogen or light emitting diodes (LEDs) or other sources of artificial or manufactured light. In some embodiments the term light source may include numerous lighting units that may be arranged, packaged or otherwise grouped into a set or array of LED's. In some embodiments an array or group of LED's may be packaged or included in one or more installation units, such as in a unit that may be accommodated into one or more light or electrical fixtures. In some embodiments a light source may be packaged or associated with one or more processors, light sensors, such as light sensors, and memory units that may operate one or more of the LED's that are included in or associated with such one or more light sources. In some embodiments, one or more of the LED's in an array may be operated at various times, cycles, intensities and periods, together with or independent of the other LED's in the same or another array. One or more of such operational functions may be controlled by one or more processors and may be monitored by one or more light sensors. In some embodiments, a position and installation of a light source may be known or derivable relative to other light sources in an installation and relative to objects in a room such as furniture, walls or windows. In some embodiments a light source may be packaged in a size and diameter resembling a traditional fluorescent or other lamp to allow installation in a standard sized housing. In some embodiments, numerous light sources or installed bulbs may be operated from one or more processors, memories and light sensors.

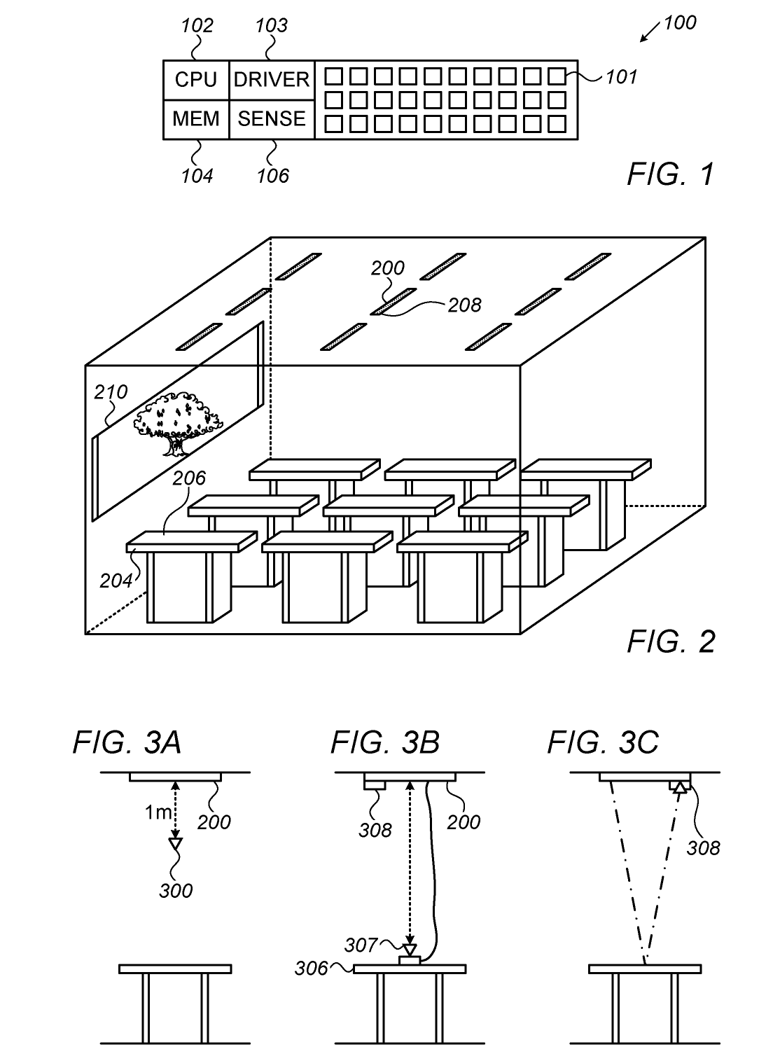

Reference is made to FIG. 1, a schematic diagram of a light source, light sensor and controller in accordance with an embodiment of the invention. A system 100 may include one or more light sources 101, such as for example LED's or arrays of LED's, that may be linked to or associated with one or more processors 102, memory 104 units, dimmable driver unit 103 (e.g., LED dimmable driver), and one or more light sensors 106. In some embodiments, light sensor 106 is at known or identifiable position relative to light sources 101. In some embodiments one or more of the light sources 101 may be designated or associated with an identifier such as a unique identifier, and such identifier may be input to or known by and accessible to processor 102 and memory 104. In some embodiments an intensity or service cycle of a light source 101 may be adjustable by, for example, a signal issued from processor 102.

In some embodiments, a processor 102 is, for example, a central processing unit (CPU), a chip or any suitable computing or computational device. In some embodiments, memory 104 may store any executable code, e.g., an application, a program, a process, task or script. The executable code may include codes for achieving illumination of a location according to some embodiments of the invention. The executable code may be executed by processor 102 possibly under control of any known operating system.

Memory 104 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 104 may be or may include a plurality of, possibly different memory units.

In some embodiments, dimmable driver 103 converts a processor intensity calculation into a light source equivalent power, and processor 102 may use pseudo random time slots for one or more lamps to alter an illumination among the lamps while not interfering with the other lamps. The pseudo random time slot may be generated by processor 102 using any known pseudo random method.

Reference is made to FIG. 2, which is a schematic diagram of a light source installation in accordance with an embodiment of the invention. In some embodiments one or more light sources 200 may be installed in a room or other space that may include floors, walls or furniture 204, where such furniture 204 such as a desk, table or chair may include one or more surfaces 206. FIG. 2 shows a room, such as a classroom having nine light housings 208, a window 210, walls and several desks, though other configurations are possible. Variability in such configurations may include ceiling heights, floors or furniture or other materials having differing reflective qualities, changes to lighting from external sources, and other variable conditions.

Embodiments of the invention may employ a closed-loop or other mechanisms of control (e.g., by processor 102) that may adjust an intensity or activation cycle of one or more light sources to a level that may reduce lighting energy consumption while maintaining designated illumination conditions at or on one or more surfaces 206 or other areas of a space that may have a fixed, variable or changeable configuration.

Reference is made to FIGS. 3A, 3B and 3C which are schematic diagrams of light sources, light sensors and surfaces in accordance with some embodiments of the invention. In some embodiments, upon an installation of a system of an embodiment of the invention, or at some other time, processor 102 may receive and store on memory a 104 unique identifier of one or more light sources installed in a room or in another space.

Referring to FIG. 3A, for one or more light sources 200, there may be defined a value I1 that denotes the amount of light measured by a light sensor 300 positioned at distance d1 (e.g. 1m) when the light source 200 is the only light source (no ambient light, and other lamps are turned off). The value I1 may be measured during production of the light source 200 as is determined by light sensor 300 positioned at distance d1 or at some other time.

Referring to FIG. 3B, during or after installation of system 100 or at some other time or times, a measurement may be taken of a distance between light sensor 307, which may be or may include a device to measure distances between two objects. Light sensor 307 may collect a distance between one or more light sources 200 or light sensors 308 and one or more surfaces 306, such as a table level, floor level or other surface 306 level in an area of such light source 200 or light sensor 308. Such distances may be measured either manually or automatically by one or more light sensors 307. Distances of more than one light source 200 or light sensor 308 to more than one surface 306 may be measured and stored by memory 104, and associated with each such light source 200 or light sensor 308. In some embodiments collected, transmitted and stored information may include unique identifiers for the various light sources 200 (e.g. for a classroom with 18 lamps, the lamps with assigned ID's 1, 2, 3 . . . 18), the distance (denoted dₘ) between on or more lights source 200 or light sensors 308 and one or more surfaces 306, and for example a time of day.

In some embodiments, a calibration of the light sources may be undertaken following an installation or at some other time, such as during a night or dark period after the installation. Such calibration may provide processor 102 with information to calculate the amount of light available at surface 306 from an amount of light produced by light source 200 as is measured by light sensor 308.

A calibration process may be initiated for example during a night or dark time (e.g. 3 AM) after the installation when a space is guaranteed to be dark (e.g. based on readings from one or more light sensors 308 indicating that the space is sufficiently dark for calibration). Light sources 200 may be assigned separate time slots, such as by associating a time slot with a light source identified (e.g. lamp 1 will calibrate at 3:00 am, lamp 2 will calibrate at 3:05, etc.).

Referring to FIG. 3C, for each light source, 200 at the assigned time, processor 102 may turn the light on to for example a maximum intensity (100%) and may measure the reflected light using sensor 308. This measurement may be denoted Im and it may describe for example a level or amount of light reflected from surface 306 and detected by sensor 308. This measurement may be repeated for different light intensities (i.e. 90%, 80%, . . . 0%) of light source 200. The measurements may be stored in memory 104.

An attenuation function λ_{L}(d ₁, d ₂) may be defined as the ratio between the intensity of light measured at distance d₁ and d₂ for a lamp of length L. For a short lamp (e.g. 0.6m) this may be approximately similar to a spot light source and then:

$${λ}_{L} ( {d}_{1} , {d}_{2} ) ≅ {( \frac{{d}_{2}}{{d}_{1}} )}^{2} .$$

For a longer lamp (e.g. 1.2m), the following function may be used:

$${λ}_{L} ( {d}_{1} , {d}_{2} ) ≅ \frac{{d}_{2} arctan ( \frac{L}{2 {d}_{1}} )}{{d}_{1} arctan ( \frac{L}{2 {d}_{2}} )}$$

Once d₁, dₘ, I₁, Iₘ are defined, processor 102 may calculate an absorbance factor defined for example, as

$$α = {λ}_{L} ( {d}_{1} , {d}_{m} ) \frac{{I}_{m}}{{I}_{1}} ,$$

which gives the ratio between the amount of light measured by a specific light sensor 308 and the actual light seen at the surface 306 level. When light sensor 308 of a specific lamp measures an amount of light, wherein the actual amount of light at surface 306 level may be estimated as

$$\frac{1}{α} {I}_{s} .$$

Other factors α may be used. In some embodiments, the absorbance factor may allow a calculation of the illumination level actually existing at surface 306 based on the illumination level detected by light sensor 308.

Light absorbance factors for one or more light sources 200 and surfaces 306 may be periodically calculated for example automatically once a week or once a month, or can be initiated manually or with other periodicity.

Information collected from the installation and calibration process may be used, together with real time light measurement to adjust an intensity of one or more light sources 200 so that a desired level of illumination is achieved and maintained at one, some or all surfaces 306, and a requisite or optimal level of illumination is produced to achieve and maintain such levels of illumination, while reducing or minimizing energy use.

In some embodiments, a calibration process proceeds as follows: Initially, all light sources may be turned on to an initial intensity of for example 50%. After a short initial delay of for example 100-200 milli-seconds, one or more processors may initiate an iterative process of measuring the light reflected from surface 306 and adjusting the intensity of a light source 200, so that a requisite or desired illumination level is achieved at a surface 306 level using a minimum of produced light and energy. This minimum level may be denoted as Iₘᵢₙ, which may be for example 500 Lux. When processor 102 and light sensor 308 detects that its light source 200 needs no more adjustments, it may stop the iterations. A process of adjustment may be repeated for example every 30 minutes or with other periodicity.

According to some embodiments, processor 102 may be assigned a time to start the iterative adjustment process based on for example the unique ID of the light source or on some other basis, so that, for example, every 10 milliseconds (ms) a different light source 200 will start calibrating. The starting time in milliseconds for lamp i may be calculated as l₀(i)=100+10 μ(i) where μ denotes a predefined permutation on the order of the light sources.

To increase stability, a tolerance level may be defined when comparing a current detected illumination with a desired level of illumination (Iₘᵢₙ). Such tolerance may be denoted Iₜₒₗ. According to one embodiment, the tolerance value may be 50 Lux though other tolerances are possible. A correction may be applied if the measured light is lower than Iₘᵢₙ−Iₜₒₗ or higher than Iₘᵢₙ+Iₜₒₗ, provided that the light source is not already at the extreme values (i.e. at 0% when there is too much light, or at 100% when there is not enough light).

At one, some or each iteration, the processor may collect illumination levels from light sensor 308 (denote this reading Iₛ), and use such measurement, and the known current lamp intensity (denoted P₀, a value between 0%-100%) to calculate the new lamp intensity

$${p}_{1} = {p}_{0} ( 1 + γ \frac{{I}_{min} - {I}_{s / α}}{{I}_{min}} ) .$$

Where γ is a restraining factor, set to a value such as 0.5, meaning that only a fraction of the correction to each light source is made. This is used to avoid instability and interference between the multiple light source corrections. The calculated value P₁ may be fixed to be in the range 0-100% if needed.

The timing of a next iteration may be determined as a random or pseudo random delay of 50 ms to 100 ms. The pseudo random can be done using the internal clock of the micro-controller. Other delays and basis of determining delays may be used. This allows fast stabilization of all light sources, while ensuring each source stabilizes its intensity without interference from neighboring light sources.

A processor may count or record a number of iterations in which no or minimal correction was needed. Upon reaching a pre-defined number (such as 5) of correctionless iterations, or iterations with corrections that are smaller than for example 1%, the iteration process may be stopped for one or more light sources until a next round of calibration is initiated.

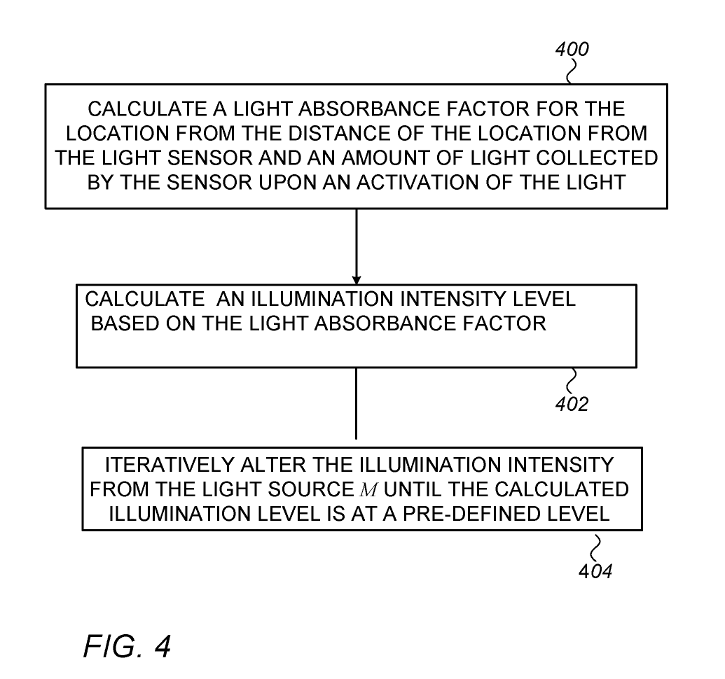

Reference is made to FIG. 4, which is a flow diagram of a method of controlling an illumination level at a location in accordance with an embodiment of the invention. In block 400, a calculation may be made of a light absorbance factor for the location by calculating at least a distance of the location from a light sensor (e.g., light sensors 106, 307 and 308) and an amount of light collected by the light sensor upon an activation of a light source (e.g., light source 101 and 200) as is installed near the location. In some embodiments, the absorbance factor may be calculated from or as a function of at least a distance of the location to be illuminated from the one or more light sensors and a reflectivity of the location as such reflectivity is collected from a light sensor associated with the light source during a period when no other light source is illuminating the area. In some embodiments, the reflectivity of the location may be compared to an illumination level collected from the light source at a pre-defined distance and at a predefined light generation level of the light source. In block 402, an illumination level of the location may be calculated based on the calculated absorbance factor. In block 404, the illumination intensity from the light source may be iteratively altered until the calculated illumination level of the location is at a pre-defined level.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention

1. A method for controlling an illumination level of a location, the method comprising:
calculating a light absorbance factor for said location, said light absorbance factor being a function of at least a distance of said location from a light sensor and an amount of light collected by said light sensor in an area of said location upon an activation of a light source;
calculating an illumination level based on the calculated light absorbance factor; and
iteratively altering an illumination intensity of said light source until said calculated illumination level of said location is achieved.

2. The method as in claim 1, wherein said iteratively altering comprises collecting, upon said altering, an illumination level at said fight sensor.

3. The method as in claim 1, wherein said iteratively altering an illumination intensity of said light source until said calculated illumination level of said location is achieved, comprises iteratively altering an illumination intensity of said light source until said calculated illumination level is within a pre-defined tolerance range.

4. The method as in claim 1, wherein said calculating comprises calculating a light absorbance factor for said location, said absorbance factor being a function of at least (i) a distance of said location from a light sensor, (ii) an illumination level created by said light source and detected by said light sensor at a known distance from said light source, and (iii) a reflectivity of said location.

5. The method as in claim 1, wherein said iteratively altering an illumination intensity of said light source until said illumination level of said location is achieved, comprises iteratively altering an illumination intensity of said light source from among a plurality of light sources until said illumination level of said location is achieved.

6. The method as in claim 1, wherein said location is a surface.

7. A system for controlling an illumination level of a location, said system comprising:
a light source;
a processor,
a memory
a light sensor, wherein
said light source is to produce an illumination;
said light sensor is to measure an illumination level;
said memory is to store a measure of distance between said light sensor
and said location and to store an illumination level produced by said light
source at a pre-defined distance;
said processor is to:
calculate a light absorbance factor for said location, said absorbance factor being a function of at least said distance of said light sensor and said location and a reflectivity of said location;
calculate an illumination level based on said calculated light absorbance factor; and
iteratively alter an illumination intensity of said light source until said illumination level of said location is achieved.

8. The, system as in claim 7 wherein said processor is to iteratively alter an illumination intensity of said light source until said illumination level at said location is within a pre-defined tolerance level.

9. The system as in claim 7 wherein said light sensor is to collect illumination levels at each of said iterations.

10. The system as in claim 7, comprising a dimmable LED driver, where said dimmable LED driver is to convert a processor intensity calculation into a light source equivalent power and wherein said processor is to use pseudo random time slots for each lamp to alter its illumination while not interfering with other lamps.
